(19) United States
(12) Patent Application Publication
(10) Pub. No.: US 2008/0225954 A1
(43) Pub. Date: Sep. 18, 2008

(54) IMAGE DECODING APPARATUS AND IMAGE DECODING METHOD

(75) Inventors: Tatsuhiro Suzumura, Kanagawa (JP); Takaya Ogawa, Kanagawa (JP); Akihiro Oue, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/045,977

(22) Filed: Mar. 11, 2008

(30) Foreign Application Priority Data
Mar. 13, 2007 (JP) 2007-063827

(51) Int. Cl. H04N 7/12

(52) U.S. Cl. 375/240.23

(57) ABSTRACT

The invention includes: a bitstream updating output unit configured to receive a bitstream and update a syntax element located at a beginning of the bitstream according to a code length thereof and outputs the syntax element; a bitstream decoding unit configured to decode, in response to a decode request, a variable-length code of the syntax element outputted from the bitstream updating output unit; a zerosLeft updating unit configured to update zerosLeft based on a specific syntax element decoded by the bitstream decoding unit; a run_before remaining number updating unit configured to update a run_before remaining number based on a specific syntax element decoded by the bitstream decoding unit; and a syntax selection unit configured to select a syntax element to be decoded by the bitstream decoding unit. Thus, multiple zero run_before syntaxes and one non-zero run_before syntax, or multiple zero run_before syntaxes are decoded all at once.

### CROSS REFERENCE TO RELATED APPLICATION

This application is based upon and claims the benefit of priority from the prior Japanese Patent Application No. 2007-63827 filed on Mar. 13, 2007; the entire contents of which are incorporated herein by reference.

### BACKGROUND OF THE INVENTION

1. Field of the Invention

The present invention relates to an image decoding apparatus and image decoding method configured to decode an image coding bitstream (coded image data) coded in H.264 format.

2. Description of the Related Art

The technique called ITU-T Recommendation H.264/AVC (Advanced video coding) (simply “H.264” hereafter) defines that DCT coefficients, motion vectors or the like be transmitted using syntaxes indicating the rules of setting coded data streams (bitstreams).

For example, in compressing and coding moving image data and transmitting the resultant data, motion prediction errors (residual blocks) between input data of luminance or color difference and motion-compensated output based on precedent-screen data are calculated for each processing block, and DCT coefficients of the residual blocks are quantized and variable-length coded and then transmitted to the decoder side.

As the advanced technique of coding DCT coefficients, CAVLC (Context-Adaptive Variable Length Coding) is used. A processing block size (processing unit) of DCT coefficients are, for example, 4□4, and sixteen DCT coefficients are converted into the following seven pieces of syntax element information (simply “syntax” hereafter) (run_before, level_Prefix, level_suffix, TotalCoeff, total_zeros, TrailingOnes, trailing_ones_sign_flag), so that all the sixteen DCT coefficients can be specified using these seven pieces of information.

run_before is the number of continuous “0s” before a non-zero coefficient value; level_prefix and level_suffix are non-zero coefficient values; TotalCoeff is the number of non-zero coefficients; total_zeros is the number of “0s” before the last non-zero coefficient; TrailingOnes is the number of the last continuous coefficients having an absolute value of 1; trailing_ones_sign_flag is the code of the last continuous coefficients having an absolute value of 1.

In the decoder side, all DCT coefficients quantized, for example, in order of zigzag scanning can be decoded based on the seven pieces of information (run_before, level_prefix, level_suffix, TotalCoeff, total_zeros, TrailingOnes, trailing_ones_sign_flag).

In a residual block, there are ((the number of non-zero coefficients)−1)-number of run_before syntaxes; when decoding is carried out using a table defined in H.264 standards, the number of multiple run_before syntaxes which can be decoded by a single decode command is only one. That is, according to a conventional art, decoding must be carried out for each non-zero run_before (run_before 10) and zero run_before (run_before□0).

Consequently, as the number of non-zero coefficients (that is, the number of coefficient data) increases, the number of cycles of processing the residual block becomes larger, thus deteriorating decoding performance.

In one code stream (bitstream), there are ((the number of non-zero coefficients)−1)-number of run_before syntaxes. ((the number of non-zero coefficients)−1) can also be expressed as ((TotalCoeff)−1).

Meanwhile, as a related art of coding and decoding by H.264, there is one described in Japanese Patent Application Laid-Open No. 2006-135786, for example. However, in Japanese Patent Application Laid-Open No. 2006-135786, there is no description of the technique of suppressing the increase in the number of decode cycles.

### SUMMARY OF THE INVENTION

According to an aspect of the present invention, there is provided an image decoding apparatus including: a bitstream updating output unit configured to receive a bitstream and update a syntax element located at a beginning of the bitstream according to a code length thereof and outputs the syntax element; a bitstream decoding unit configured to decode, in response to a decode request, a variable-length code of the syntax element outputted from the bitstream updating output unit; a zerosLeft updating unit configured to update zerosLeft based on a specific syntax element decoded by the bitstream decoding unit; a run_before remaining number updating unit configured to update a run_before remaining number based on a specific syntax element decoded by the bitstream decoding unit; and a syntax selection unit configured to select a syntax element to be decoded by the bitstream decoding unit, wherein multiple zero run_before syntaxes and one non-zero run_before syntax, or multiple zero run_before syntaxes are decoded all at once.

According to another aspect of the present invention, there is provided a image decoding method including: updating a syntax element located at a beginning of an input bitstream according to a code length thereof and outputting the bitstream; issuing a decode command for a syntax element to be decoded; decoding a variable-length code of the syntax element in response to the decode command; updating the run_before remaining number based on a specific syntax element decoded; updating zerosLeft based on a specific syntax element decoded; and receiving the zerosLeft and the beginning of the bitstream and decoding multiple zero run_before syntaxes and one non-zero run_before syntax all at once using a first table group (20Xa), or receiving the zerosLeft, the beginning of the bitstream and the run_before remaining number and decoding multiple zero run_before syntaxes all at once using a second table group (20Xb).

According to another aspect of the present invention, there is provided a image decoding method including: updating a syntax element located at a beginning of an input bitstream according to a code length thereof and outputting the bitstream decoding a variable-length code of the syntax element in response to a decode request; updating the run_before remaining number based on a specific syntax element decoded; updating zerosLeft based on a specific syntax element decoded; receiving the zerosLeft and the beginning of the bitstream and decoding multiple zero run_before syntaxes and one non-zero run_before syntax all at once using a first table group (20Xa), or receiving the zerosLeft, the beginning of the bitstream and the run_before remaining number and decoding multiple zero run_before syntaxes all at once using a second table group (20Xb).

### BRIEF DESCRIPTION OF THE DRAWINGS

FIG. 1 is a block diagram of an image decoding apparatus according to an embodiment of the present invention;

FIGS. 2A to 2N are diagrams illustrating tables 20Xa and 20Xb used in the embodiment of the present invention;

FIG. 3 is an explanatory diagram of the decoding operation of FIG. 1;

FIG. 4 is a block diagram illustrating a hardware configuration which selects one from the tables 20Xa and 20Xb in the variable-length decoding apparatus;

FIG. 5 is an explanatory diagram of the run_before remaining number;

FIG. 6 is a block diagram of the run_before remaining number updating circuit used in the embodiment of the present invention;

FIG. 7 is a diagram illustrating an exemplary bitstream being a coded data stream;

FIG. 8 is a block diagram of an image decoding apparatus according to a related art of the present invention;

FIGS. 9A to 9G are diagrams illustrating a table group (the same as one described in H.264 standards) used in the related art illustrated in FIG. 8; and

FIG. 10 is an explanatory diagram of the decoding operation of FIG. 8.

### DETAILED DESCRIPTION OF THE PREFERRED EMBODIMENTS

Embodiments of the present invention will be described with reference to the drawings.

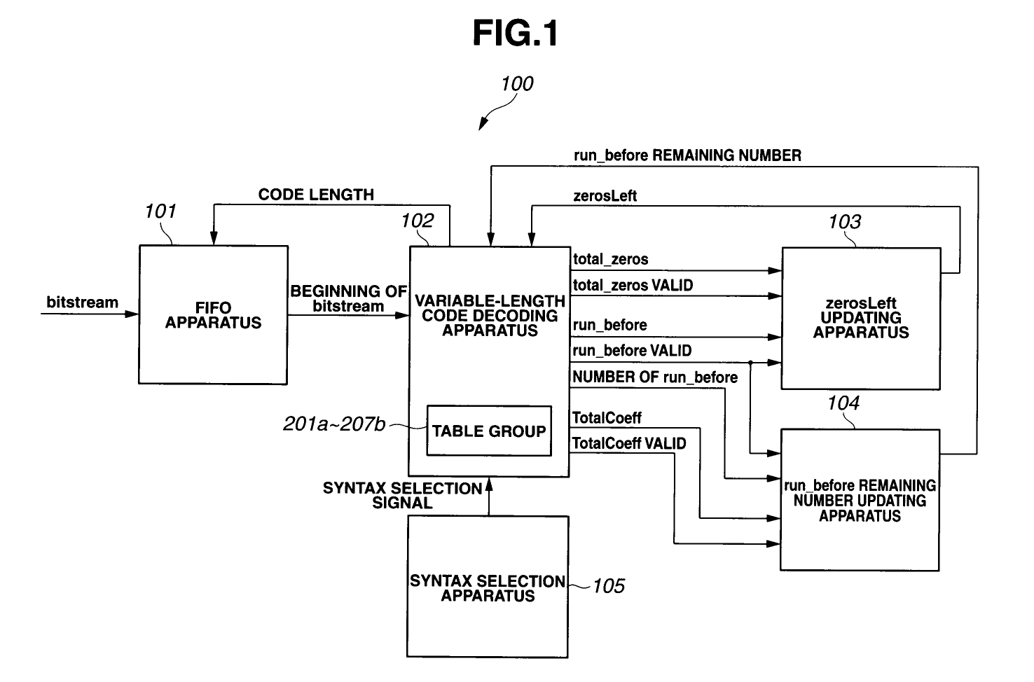

Before describing embodiments of the present invention with reference to FIGS. 1 to 6, a related art of the present invention will be described with reference to FIGS. 7 to 10.

FIG. 7 is a diagram illustrating an exemplary bitstream being variable-length coded data. The bitstream is constituted of multiple syntax elements (simply “syntax” hereafter) indicating the rule of setting the bitstream. For example, in the bitstream, there are multiple syntaxes continuously arranged, for example, syntax A, syntax E, □□run_before syntax, □□ as illustrated in FIG. 7. Symbol □ indicates a point at which a run_before syntax group containing ((the number of non-zero coefficients)−1)-number of run_before syntaxes starts. In order to distinguish the syntax group containing the predetermined number of run_before syntaxes from individual syntaxes, the syntax group can be referred to as “the entire run_before syntax”. That is, the entire run_before syntax contains a predetermined number of individual run_before syntaxes. The beginning of a run_before syntax can be detected based on another syntax portion of the preceding run_before syntax.

A bitstream constituted of multiple types of syntaxes containing run_before syntax is supplied as input data to the image decoding apparatus. The whole bitstream is constituted of syntaxes from the beginning to an ending; but in the decoding unit of the image decoding apparatus, each time decoding of each syntax is finished, the decoded syntax is discarded; thus each time decoding of each syntax is finished, a subsequent syntax corresponding to the beginning of the bitstream is inputted to the decoding unit of the image decoding apparatus.

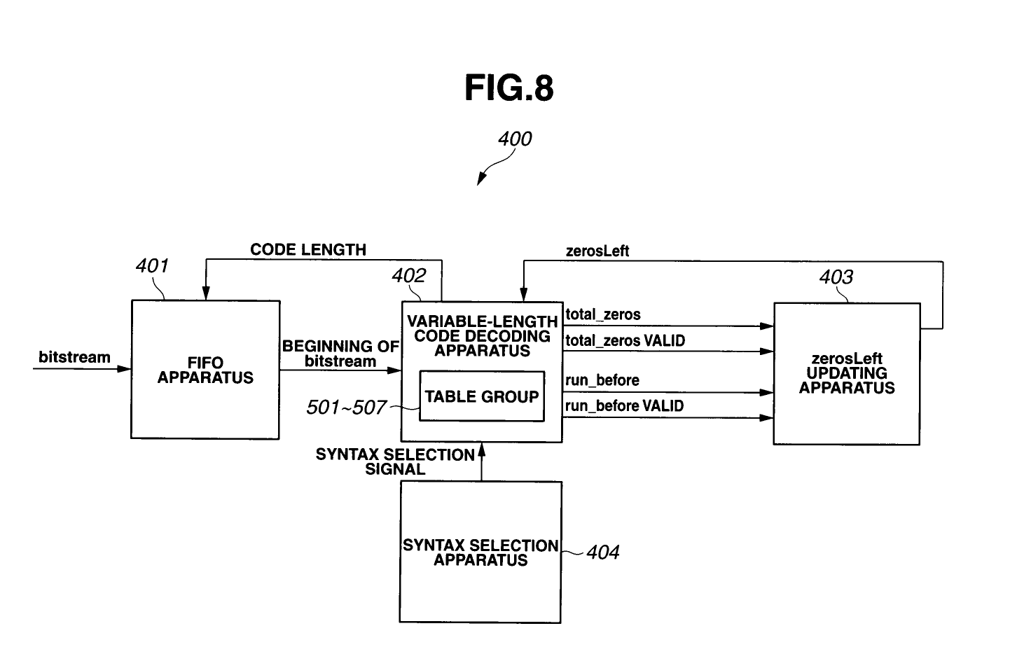

FIG. 8 is a block diagram of an image decoding apparatus according to a related art of the present invention.

An image decoding apparatus 400 illustrated in FIG. 8 is constituted of hardware configured to decode run_before syntax, and includes an FIFO apparatus 401, variable-length code decoding apparatus 402, zerosLeft updating apparatus 403 and syntax selection apparatus 404. The variable-length code decoding apparatus 402 is provided with a table group of tables 501 to 507. zerosLeft will be described later.

The operation in FIG. 8 will be described.

The FIFO apparatus 401 receives a variable-length coded bitstream and outputs the bitstream in input order. While updating syntaxes located at the beginning of the bitstream one after another, the FIFO apparatus 401 supplies the updated syntax to the variable-length code decoding apparatus 402. When receiving the beginning of the bitstream from the FIFO apparatus 401, the variable-length code decoding apparatus 402 identifies the type of syntax and decodes the syntax, and after the decoding operation, detects the code length of the decoded syntax. Then, the detected code length is provided to the FIFO apparatus 401. When receiving the code length, the FIFO apparatus 401 determines that the syntax corresponding to the code length has already been decoded, and discards the syntax. As a result, the beginning of subsequent bitstream data (subsequent syntax) is outputted from the FIFO apparatus 401, i.e., the syntax is updated and sent to the variable-length code decoding apparatus 402. The variable-length code decoding apparatus 402 decodes the subsequent syntax and provides the code length thereof to the FIFO apparatus 401; in this way, decoding is carried out for each syntax.

In response to a total_zeros decode command from the syntax selection apparatus 404, firstly the variable-length code decoding apparatus 402 decodes total_zeros syntax and sends the decoded syntax to the zerosLeft updating apparatus 403 along with a valid signal. The zerosLeft updating apparatus 403 updates zerosLeft; the zerosLeft updating apparatus 403 receives total_zeros (an initial value of zerosLeft) decoded by the variable-length code decoding apparatus 402 and decoded run_before along with respective valid signal, and each time run_before is received, carries out updating calculation using an updating calculation formula (zerosLeft−run_before) by using total_zeros as the initial value of zerosLeft, so that updating zerosLeft is repeated until zerosLeft changes to 0. zerosLeft indicates the number of run_before syntaxes which remains to be decoded when the run_before thereof is decoded, and its initial value is equal to total_zeros.

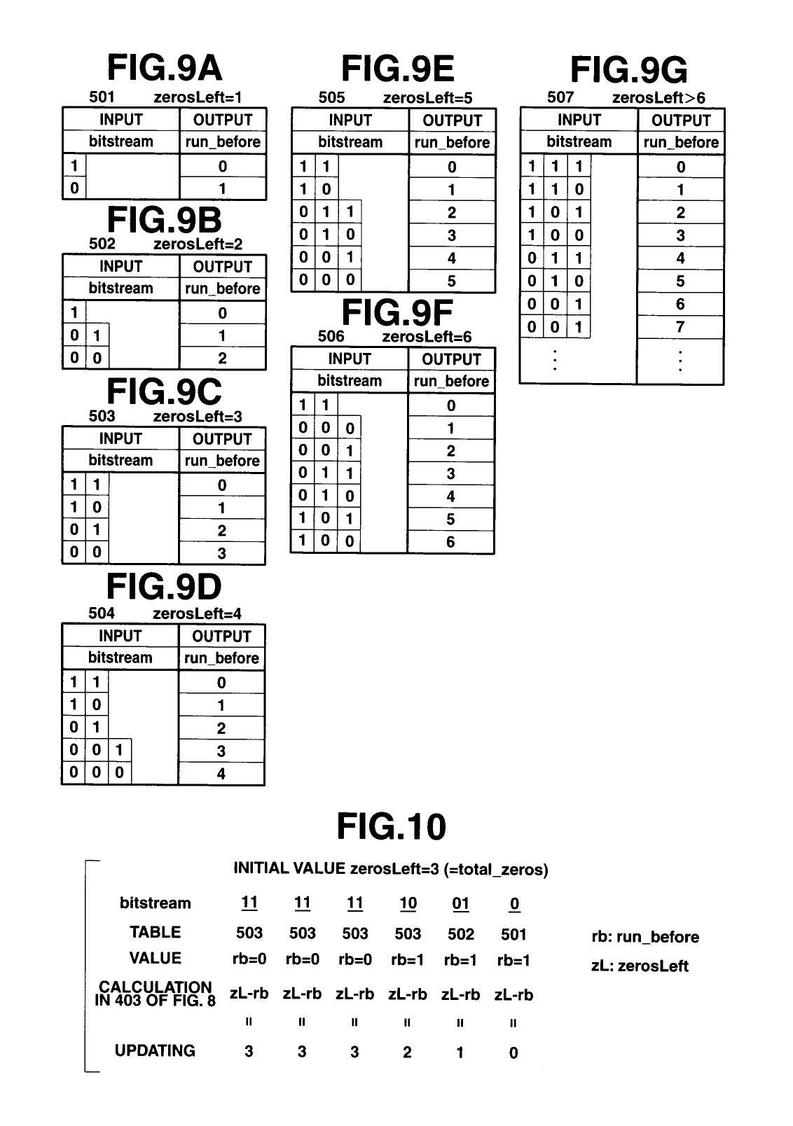

Subsequently, in response to a run_before decode command from the syntax selection apparatus 404, the variable-length code decoding apparatus 402 receives zerosLeft from the zerosLeft updating apparatus 403, and determines (selects) based on the zerosLeft information, a decode table to be used from among tables 501 to 507 illustrated in FIGS. 9A to 9G. In this case, a table corresponding to the zerosLeft information is selected. Thus, run_before can be decoded and outputted using the selected decode table.

Then, the value of run_before (decode output) obtained from the table is sent to the zerosLeft updating apparatus 403 along with the valid signal. The zerosLeft updating apparatus 403 updates zerosLeft based on the updating calculation formula, using the value of run_before. If the updated zerosLeft is not equal to zero, the syntax selection apparatus 404 outputs a run_before decode command again. Decoding run_before and updating using the decoded value are repeated until zerosLeft changes to 0.

The decoding operation of the variable-length code decoding apparatus 402 of FIG. 8 will be described with reference to the drawings illustrating the table group (501 to 507) of FIGS. 9A to 9G and an operation explanatory diagram of FIG. 10.

Descriptions will be given by taking as an example, a case where the whole run_before syntax indicated as a variable-length coded bitstream is ‘11111110010’ as illustrated in FIG. 7.

In FIG. 10, ‘bitstream’ denotes run_before syntax ‘11111110010’ being a variable-length coded bitstream; ‘table’ denotes the number of each decode table which is selected for each syntax among the table group (501 to 507) illustrated in FIGS. 9A to 9G (for each one- to three-digit indicated as the input in FIGS. 9A to 9G); ‘value’ denotes a decode value of run_before (otherwise “rb” for short); ‘updating’ denotes updating of zerosLeft (otherwise “zL” for short), i.e., updating of a decode table used. Here, in FIG. 10, zL−rb (=zerosLeft−run_before) denotes an updating calculation formula of the zerosLeft updating apparatus 403, and underlines attached to each two-digit (however, one digit in the last part) of ‘bitstream’ correspond to one decode cycle.

Firstly, based on a zerosLeft syntax having sent before a run_before syntax is sent, the variable-length code decoding apparatus 402 selects from among run_before decoding tables illustrated in FIGS. 9A to 9G and consults the selected table. When the initial value of zerosLeft syntax is (zerosLeft=3) (=total_zeros), the table 503 is selected. In the table 503, two digits at the beginning of the bitstream are shown as the input; when two-digit syntax ‘11’ at the beginning of the bitstream is inputted, run_before obtained as the decode output through the table 503 is ‘0’ (rb=0). In this case, the code length is 2. And the calculation result of the updating calculation formula is zL−rb=3; in this case, zerosLeft is equal to the initial value thereof, so the table is not updated. As a result, the same table 503 is also used for the subsequent two-digit syntax ‘11’; thus similarly, rb=0, and zL−rb=3. Accordingly, zerosLeft is equal to the initial value thereof, so the table is not updated. Consequently, with the subsequent third two-digit syntax ‘11’, also, the same table 503 is used. Then, with the subsequent forth two-digit syntax ‘10’, run_before obtained as the decode output through the table 503 is ‘1’ (rb=1). In this case, the updating calculation formula is zL−rb=2, and then zerosLeft=2, so the value of zerosLeft is updated. Here, each time a syntax at the beginning of the bitstream is updated, the syntax selection apparatus 404 outputs a decode command.

Consequently, the decode table to be subsequently used is the table 502 corresponding to zerosLeft=2. When the fifth two-digit syntax ‘01’ of the bitstream is inputted, run_before obtained as the decode output through the table 502 is ‘1’ (rb=1), and the updating calculation formula zL−rb=1, and zerosLeft=1, so the value of zerosLeft is updated. In this case, the code length is 2.

Consequently, the decode table to be subsequently used is the table 501 corresponding to zerosLeft=1. In the table 501, one-digit input is shown. When the sixth one-digit syntax ‘0’ of the bitstream is inputted, run_before obtained as the decode output through the table 501 is ‘1’ (rb=1). In this case, the code length is 1. And the updating calculation formula zL−rb=0, so the decoding is finished.

With the hardware configuration of FIG. 8, when the decode table group illustrated in FIGS. 9A to 9G is used, even though the same table 503 is used for the four syntaxes, a decode command and updating calculation are required for each syntax. Thus, the number of cycles (decode command and updating calculation) for the whole decoding is 6.

### First Embodiment

FIG. 1 is a block diagram of an image decoding apparatus according to a first embodiment of the present invention.

The image decoding apparatus 100 illustrated in FIG. 1 has the hardware configuration in which run_before syntax is decoded.

The image decoding apparatus 100 includes: an FIFO apparatus 101 acting as a bitstream updating and output unit configured to receive a bitstream constituted of multiple variable-length code syntaxes, and updates a syntax located at the beginning of the bitstream according to the code length thereof and output the updated syntax; a variable-length code decoding apparatus 102 acting as a bitstream decoding unit configured to decode the variable-length code of the syntax received from the FIFO apparatus 101 in response to a decode request; a zerosLeft updating apparatus 103 configured to update zerosLeft using as an initial value, a specific syntax (for example, total_zeros) decoded by the variable-length code decoding apparatus 102; a run_before remaining number updating apparatus 104 configured to update the run_before remaining number using as an initial value, a specific syntax (for example, TotalCoeff) decoded by the variable-length code decoding apparatus 102; and a syntax selection apparatus 105 configured to select a syntax to be decoded by the variable-length code decoding apparatus 102. The image decoding apparatus 100 decodes all at once multiple zero run_before syntaxes (meaning that the number of (run_before=0) is plural) and one non-zero run_before syntax (meaning that the number of (run_before□0) is one), or multiple zero run_before syntaxes. The variable-length code decoding apparatus 102 is provided with a table group of decode tables 201a to 207b. As illustrated in FIG. 6, the run_before remaining number updating apparatus 104 includes a multiplex (MUX) 301 being a selection circuit, a register 302 and a subtracter 303 (FIG. 6 will be described later).

The operation in FIG. 1 will be described.

The variable-length code decoding apparatus 102 receives the beginning of a bitstream as input data (syntax) from the FIFO apparatus 101.

In response to a TotalCoeff decode command from the syntax selection apparatus 105, the variable-length code decoding apparatus 102 decodes TotalCoeff syntax and sends the syntax to the run_before remaining number updating apparatus 104 along with a valid signal. In the run_before remaining number updating apparatus 104, firstly the MUX 301 selects TotalCoeff as illustrated in FIG. 6, and (TotalCoeff−1) equivalent to the maximum value of the number of run_before syntaxes is written as an initial value to the register 302 (FIG. 6 will be described later).

Subsequently, in response to a total_zeros decode command from the syntax selection apparatus 105, the variable-length code decoding apparatus 102 decodes total_zeros and outputs total_zeros to the zerosLeft updating apparatus 103 along with a valid signal. The zerosLeft updating apparatus 103 updates zerosLeft using total_zeros as an initial value.

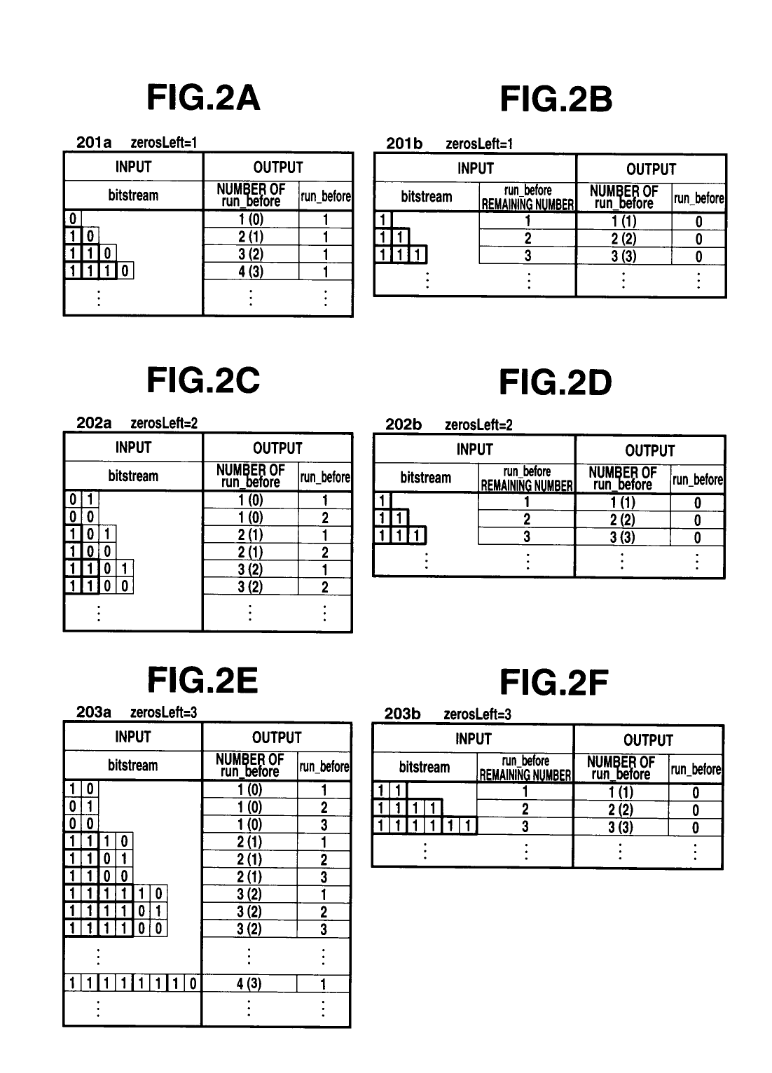

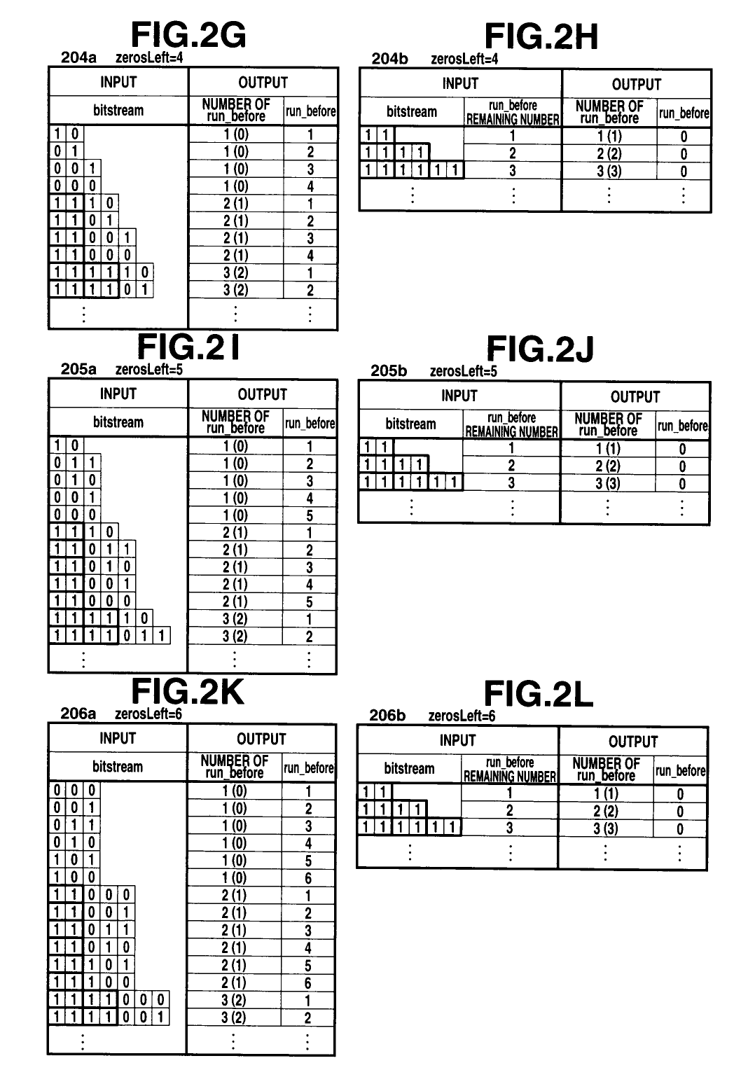

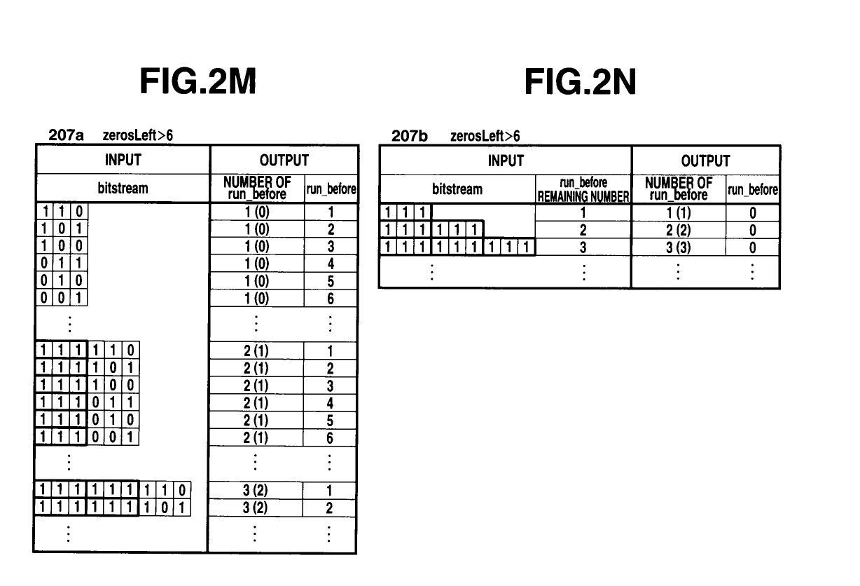

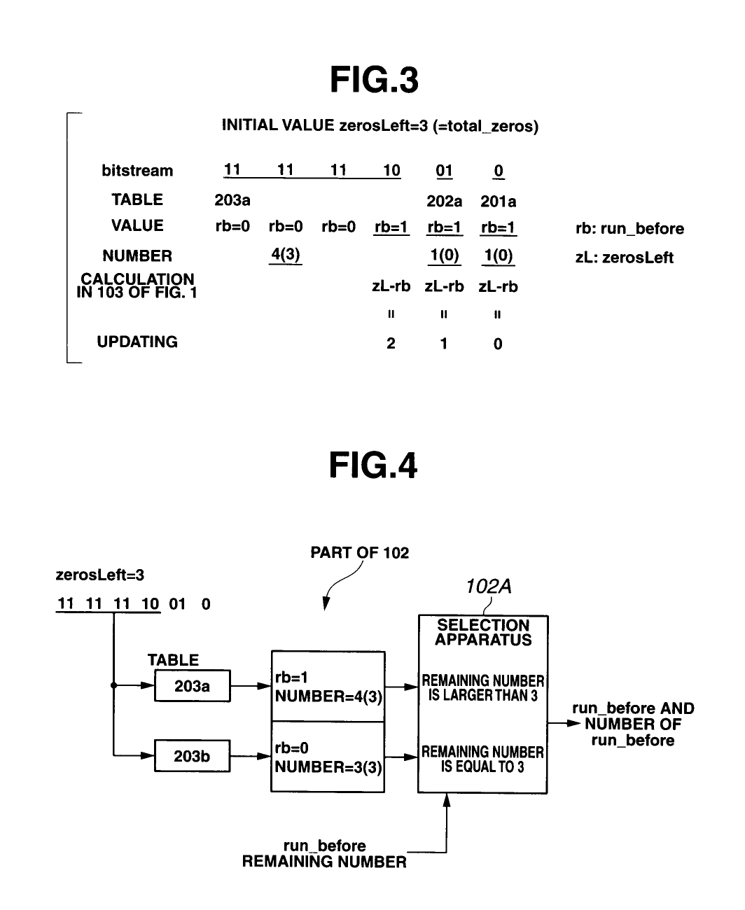

Subsequently, in response to a run_before decode command from the syntax selection apparatus 105, the variable-length code decoding apparatus 102 receives zerosLeft and the run_before remaining number respectively from the zerosLeft updating apparatus 103 and the run_before remaining number updating apparatus 104. Then, firstly the variable-length code decoding apparatus 102 determines a table number (201a to 207b) (refer to FIGS. 2A to 2N) based on the zerosLeft information (the tables 201a to 207b are classified into ones with suffix ‘a’ and ones with suffix ‘b’, which are described as 20Xa and 20Xb, respectively. Accordingly, 20Xa corresponds to any of the tables 201a to 207a with suffix ‘a’ illustrated in FIGS. 2A, 2C, 2E, 2G, 2I, 2K and 2M; 20Xb corresponds to any of the tables 201b to 207b with suffix ‘b’ illustrated in FIGS. 2B, 2D, 2F, 2H, 2J, 2L and 2N.)

Subsequently, the variable-length code decoding apparatus 102 consults a table (20Xb) with table number suffix ‘b’ selected based on the beginning of the input bitstream and run_before remaining number. If the beginning of the input bitstream and run_before remaining number agree with the input of the table 20Xb, the number of run_before syntaxes and run_before=0 corresponding to this input are selected as the output. If there is no input of the table 20Xb which agrees with the beginning of the input bitstream and run_before remaining number, the table 20Xa is consulted, so that the number of run_before syntaxes and the value of run_before are selected as the output.

The variable-length code decoding apparatus 102 sends the selected value of run_before and a run_before valid signal to the zerosLeft updating apparatus 103, and also sends the selected number of run_before syntaxes and the run_before valid signal to the run_before remaining number updating apparatus 104.

The zerosLeft updating apparatus 103 has a function similar to the zerosLeft updating apparatus 403 described with reference to FIG. 8, and receives the total_zeros (the initial value of zerosLeft) decoded by the variable-length code decoding apparatus 102 and the decoded run_before along with respective valid signals, and each time run_before is inputted, carries out updating calculation using an updating calculation formula (zerosLeft−run_before) by using total_zeros as the initial value of zerosLeft, so that updating zerosLeft is repeated until zerosLeft changes to 0.

While the zerosLeft updating apparatus 103 updates zerosLeft, in the run_before remaining number updating apparatus 104, as illustrated in FIG. 6, the subtracter 303 subtracts the number of run_before syntaxes received from the variable-length code decoding apparatus 102 from the run_before remaining number received from the register 302, and the MUX 301 selects the resultant value to update the value of the register 302. If zerosLeft updated by the zerosLeft updating apparatus 103 is not equal to 0 and at the same time the run_before remaining number in the run_before remaining number updating apparatus 104 is not equal to 0, the syntax selection apparatus 105 outputs a run_before decode command again. Decoding run_before is repeated until zerosLeft or run_before remaining number changes to 0.

When the decoding operation is performed as described above, a plurality of zero run_before syntaxes and one non-zero run_before syntax, or a plurality of zero run_before syntaxes can be decoded in one cycle. For example, when the beginning of the bitstream is ‘1101’ and zerosLeft is 2 and run_before remaining number is 6 at the time of decoding run_before, and when the decoding is carried out using the image decoding apparatus according to the present embodiment, firstly the tables 202a/202b are selected based on the zerosLeft information ‘2’. Since run_before remaining number is 6, there is no corresponding input item in the table 202b, so subsequently the table 202a is consulted. ‘1101’ corresponds to the fifth input item of the table 202a, and the number of run_before syntaxes is 3 (2) in the output item. Accordingly, two run_before syntaxes (run_before=0) and one run_before syntax (run_before=1) are decoded. Here, in the table 20Xa, the number of run_before syntaxes 3 (2) means that ‘3’ is the number of run_before syntaxes and ‘2’ is the number of run_before syntaxes (run_before=0). Thus, the number of run_before syntaxes (run_before□0) is 1.

In the above example, according to the embodiment of the present invention, decoding of three run_before syntaxes can be carried out by a single decode command. In contrast, as illustrated in FIGS. 9A to 9G, when the decoding is carried out by using the tables 501 to 507 as described in H.264 standards, the decode command must be issued three times.

There may be used another configuration in which the tables 20Xa/20Xb are selected all at once and if there is a corresponding input item in the table 20Xb, the output value of the table 20Xb is selected and if not, the output value of the table 20Xa is selected. Also, a table (for example, referred to 20X) obtained by combining the two tables 20Xa/20Xb may be used.

The operation of the image decoding apparatus 100 of FIG. 1 will be specifically described with reference to the drawings illustrating the table group (201a to 207b) of FIGS. 2A to 2N and an explanatory diagram of the operation of FIG. 3.

FIGS. 2A and 2B illustrate tables 201a and 201b, respectively; FIGS. 2C and 2D illustrate tables 202a and 202b, respectively; FIGS. 2E and 2F illustrate tables 203a and 203b, respectively; FIGS. 2G and 2H illustrate tables 204a and 204b, respectively; FIGS. 2I and 2J illustrate tables 205a and 205b, respectively; FIGS. 2K and 2L illustrate tables 206a and 206b, respectively; FIGS. 2M and 2N illustrate tables 207a and 207b, respectively.

Descriptions will be given by taking as an example, a case where the entire run_before syntax indicated as a bitstream is ‘11111110010’ as illustrated in FIG. 7.

In FIG. 3, ‘bitstream’ denotes run_before syntax ‘11111110010’ being a bitstream; ‘table’ denotes the respective numbers of the table group (201a to 207b) of FIGS. 2A to 2N; ‘value’ denotes the value of run_before (otherwise “rb” for short); ‘number’ denotes the number of run_before syntaxes; ‘updating’ denotes updating of zerosLeft (otherwise “zL” for short) (i.e., updating of a table used). Here, zL−rb (=zerosLeft−run_before) denotes an updating calculation formula of the zerosLeft updating apparatus 103 of FIG. 1, and underlines attached to each item of ‘bitstream’ denote one decode cycle. Also, in ‘number’, for example, 4 (3) means that ‘4’ is the number of run_before syntaxes and ‘3’ is the number of run_before syntaxes (run_before=0).

total_zeros syntax providing an initial value of zerosLeft is inputted to the variable-length code decoding apparatus 102 before run_before syntax is inputted.

Firstly the variable-length code decoding apparatus 102 selects for reference from among the run_before tables illustrated in FIGS. 2A to 2N based on zerosLeft syntax. When the initial value of zerosLeft syntax is (zerosLeft=3) (=total_zeros), the table 203a/203b are selected. In the input of the table 203a, there is 8-digit bitstream ‘11111110’ at the beginning of run_before syntax. Thus when the 8-digit bitstream ‘11111110’ is inputted, a run_before value ‘1’ (rb=1) is obtained as the decode output from the table 203a. In this case, the code length is 8. The result of calculation based on the updating calculation formula in the zerosLeft updating apparatus 103 is zL−rb=2; thus zerosLeft=2, and zerosLeft is updated.

In this case, with the 8-digit bitstream ‘11111110’ at the beginning, when the tables 501 to 507 of FIGS. 9A to 9G are used for decoding as described in H.264 standards, the output run_before values of respective input syntaxes ‘11’, ‘11 ’ ‘11’ and ‘10’ are, as described with reference to FIG. 10, 0, 0, 0 and 1, respectively. Thus, referring to the table 203a of FIG. 2E, the number of run_before syntaxes in the output of the table corresponding to the input ‘11111110’ is 4 (3), and the value of run_before is 1.

From the calculation result (zerosLeft=2) based on the decode output (rb=1 illustrated in FIG. 3) corresponding to the above 8-digit bitstream, the tables 202a/202b corresponding to zerosLeft=2 are selected as decode tables to be subsequently used. When the subsequent two-digit syntax ‘01’ is inputted as the bitstream, the input ‘01’ is in the table 202a. When the table 202a is consulted, a run_before value of ‘1’ (rb=1) is obtained as the decode output, and the updating calculation formula is zL−rb=1, and thus zerosLeft=1 and zerosLeft is updated.

Consequently, the table 201a/201b corresponding to zerosLeft=1 are selected as the decode table to be subsequently used. When the last one-digit ‘0’ is inputted as the bitstream, since there is the input ‘0’ in the table 201a, a run_before value of ‘1’ (rb=1) is obtained as the decode output by consulting the table 201a. And the updating calculation formula is zL−rb=0, and the decoding is finished.

When the hardware configuration of FIG. 1 is used and at the same time the decode table group (201a to 207b) illustrated in FIGS. 2A to 2N are used, the number of decode cycles using the same table 203a is one, and thus it is sufficient to carry out one decode command and updating calculation with respect to the four syntaxes. Consequently, the number of cycles (the number of decode commands and updating calculation operations) for the entire decoding is three. That is, run_before syntax can be decoded in the number of decode cycles smaller than that (6) described in the related art of FIGS. 8, 9A to 9G and 10.

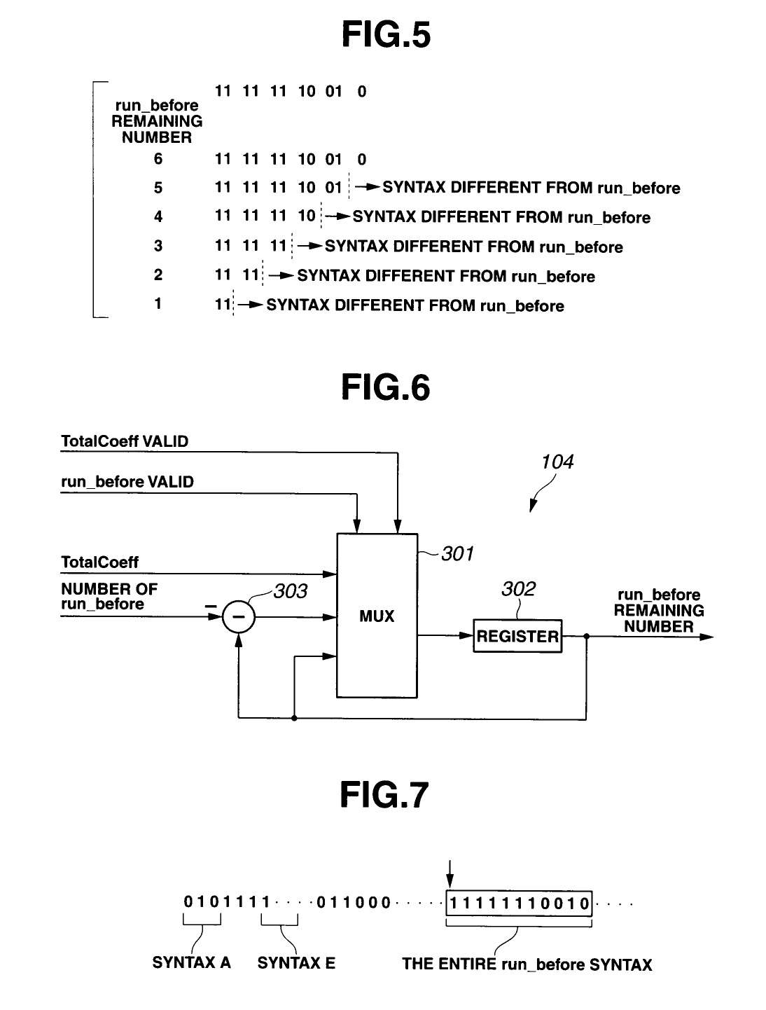

FIG. 4 illustrates a hardware configuration which selects one from between the tables 20Xa and 20Xb (for example, the above tables 203a and 203b) in the variable-length code decoding apparatus 102; FIG. 5 is an explanatory diagram of the run_before remaining number inputted to the hardware of FIG. 4.

Referring to FIG. 4, ‘11111110’ of the entire run_before syntax ‘11111110010’ is inputted as the bitstream to the variable-length code decoding apparatus 102. This input bitstream is supplied to both the tables 203a and 203b. Referring to the table 203a of FIG. 2E, with the input bitstream ‘11111110’, the number of run_before syntaxes of ‘4(3)’ and run_before=1 can be outputted. Referring to the table 203b of FIG. 2F, with the input bitstream ‘111111’, the number of run_before syntaxes of ‘3(3)’ and run_before=0 can be outputted. A selection apparatus 102A arranged in the variable-length code decoding apparatus 102 selects and outputs, according to the later described run_before remaining number, one of the outputs from the tables 203a and 203b. In the selection apparatus 102A, if the run_before remaining number is larger than 3, the output from the table 203a is selected and outputted; if the run_before remaining number is equal to 3, the output from the table 203a is selected and outputted.

In other words, the first table group (20Xa) receives zerosLeft and the beginning of the bitstream, and can decode multiple zero run_before syntaxes and one non-zero run_before all at once. The second table group (20Xb) receives zerosLeft, the beginning of the bitstream and the run_before remaining number, and can decode multiple zero run_before syntaxes all at once.

The run_before remaining number will be described with reference to FIG. 5. In the case of the entire run_before syntax ‘11111110010’ being a bitstream, when the run_before remaining number is 6, this means 6 syntaxes ‘11’, ‘11’, ‘11’, ‘10’, ‘01’ and ‘0’ obtained by setting the 11-digit number ‘11111110010’ to be decoded as the decoding unit and dividing the number by two digits from the beginning; when the run_before remaining number is 5, this means 5 syntaxes ‘11’, ‘11’, ‘11’, ‘10’ and ‘01’ obtained by setting the number ‘11111110010’ to be decoded as the decode unit and dividing the number by two digits each from the beginning; when the run_before remaining number is 4, this means 4 syntaxes ‘11’, ‘11’, ‘11’ and ‘10’ obtained by setting the number ‘11111110010’ to be decoded as the decode unit and dividing the number by two digits from the beginning; when the run_before remaining number is 3, this means 3 syntaxes ‘11’, ‘11’ and ‘11’ obtained by setting the number ‘11111110010’ to be decoded as the decode unit and dividing the number by two digits each from the beginning; when the run_before remaining number is 2, this means 2 syntaxes ‘11’ and ‘11’ obtained by setting the number ‘11111110010’ to be decoded as the decode unit and dividing the number by two digits from the beginning; when the run_before remaining number is 1, this means one syntax ‘11’ obtained by setting the number ‘11111110010’ to be decoded as the decode unit and taking two digits from the beginning. When the run_before remaining number is 5, 4, 3, 2 or 1, this means that the number of run_before syntaxes to be decoded is 5, 4, 3, 2 or 1. Accordingly, for example, when the run_before remaining number is 4, a number ‘010’ following ‘11111110’ is interpreted as another syntax different from run_before.

FIG. 6 is a block diagram of the run_before remaining number updating apparatus 104.

As illustrated in FIG. 6, the run_before remaining number updating apparatus 104 includes: the register 302 configured to retain a specific syntax (for example, TotalCoeff) as an initial value of run_before remaining number so that the syntax can be updated; the subtracter 303 configured to subtract the number of run_before syntaxes received from the variable-length code decoding apparatus 102 from the run_before remaining number retained by the register 302; and the MUX 301 being a selection circuit configured to receive the initial value of the specific syntax (for example, TotalCoeff) used in the register 302, the run_before remaining number received from the subtracter 303 and an output of the register 302, and select one of the input numbers according to the presence/absence of validity and outputs the selected number to the register 302.

In the run_before remaining number updating apparatus 104, firstly the MUX 301 selects TotalCoeff received from the variable-length code decoding apparatus 102 based on a TotalCoeff valid signal received from the variable-length code decoding apparatus 102, and writes (TotalCoeff)−1 as the initial value into the register 302. Subsequently, when a run_before valid signal is received, the MUX 301 selects a value obtained when the subtracter 303 subtracts the number of run_before syntaxes from the run_before remaining number (initially equal to the initial value) retained in the register 302, and outputs the selected value, so that the value in the register 302 is updated. That is, each time the variable-length code decoding apparatus 102 finishes decoding for each run_before decode unit, the number of run_before syntaxes and a run_before valid signal received from the variable-length code decoding apparatus 102 are inputted to the run_before remaining number updating apparatus 104, so that the value in the register 302, i.e., the run_before remaining number is updated. In this case, when the TotalCoeff valid signal or the run_before valid signal is not valid, the MUX 301 selects the output of the register 302 as its input.

The advantageous effects according to the embodiment of the present invention will be described.

In the image decoding apparatus 400 according to the related art of FIG. 8, the decoding operation must be carried out for each non-zero run_before and zero run_before. Accordingly, the number of decode cycles increases, thus deteriorating decoding performance.

In the image decoding apparatus 100 according to the present invention of FIG. 1, the beginning of a bitstream being an output of the FIFO apparatus 101, zerosLeft being an output of the zerosLeft updating apparatus 103, and the run_before remaining number being an output of the run_before remaining number updating apparatus 104 are received, so that a proper table is selected from among the tables 201a to 207b and a value corresponding to the input is outputted. Accordingly, zero run_before (run_before=0) syntaxes preceding non-zero run_before (run_before□0) syntax can be decoded all at once. That is, run_before syntax can be decoded by a smaller number of decode cycles. This means that, according to the present invention, as the number of continuous ‘0s’ being run_before syntax increases, the number of decode cycles becomes smaller, compared to the conventional decoding operation. Furthermore, theoretically, as the number of non-zero remaining coefficients increases, the number of continuous ‘0s’ becomes larger. Accordingly, when the number of non-zero remaining coefficients is large, i.e., when the number of remaining coefficient decode cycles is large, the number of run_before decode cycles can be suppressed, which is particularly useful. This means that the maximum number of decode cycles for one micro block can be suppressed, thus contributing to improvement in the decoding performance of the whole decoding apparatus.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image decoding apparatus comprising:
a bitstream updating output unit configured to receive a bitstream and update a syntax element located at a beginning of the bitstream according to a code length thereof and outputs the syntax element;
a bitstream decoding unit configured to decode, in response to a decode request, a variable-length code of the syntax element outputted from the bitstream updating output unit;
a zerosLeft updating unit configured to update zerosLeft based on a specific syntax element decoded by the bitstream decoding unit;
a run_before remaining number updating unit configured to update a run_before remaining number based on a specific syntax element decoded by the bitstream decoding unit; and
a syntax selection unit configured to select a syntax element to be decoded by the bitstream decoding unit,
wherein a plurality of zero run_before syntaxes and one non-zero run_before syntax, or a plurality of zero run_before syntaxes are decoded all at once.

2. The image decoding apparatus according to claim 1, further comprising a first table group (20Xa) that receives the zerosLeft and the beginning of the bitstream and can decode a plurality of zero run_before syntaxes and one non-zero run_before syntax all at once.

3. The image decoding apparatus according to claim 1, further comprising a second table group (20Xb) that receives the zerosLeft, the beginning of the bitstream and the run_before remaining number and can decode a plurality of zero run_before syntaxes all at once.

4. The image decoding apparatus according to claim 1,
wherein the run_before remaining number updating unit includes:
a register configured to retain a specific syntax element as an initial value of the run_before remaining number so that the syntax element can be updated;
a subtracter configured to subtract the number of run_before syntaxes received from the bitstream decoding unit from the run_before remaining number retained by the register; and
a selection circuit configured to receive the initial value of the specific syntax element, the run_before remaining number received from the subtracter and an output of the register, and select one of the inputs according to the presence/absence of validity and outputs the selected one to the register, and
wherein the specific syntax element in the run_before remaining number updating unit is TotalCoeff.

5. The image decoding apparatus according to claim 2,
wherein the run_before remaining number updating unit includes:
a register configured to retain a specific syntax element as an initial value of run_before remaining number so that the syntax element can be updated;
a subtracter configured to subtract the number of run_before syntaxes received from the bitstream decoding unit from the run_before remaining number retained by the register; and
a selection circuit configured to receive the initial value of the specific syntax element, the run_before remaining number received from the subtracter and an output of the register, and select one of the inputs according to the presence/absence of validity and outputs the selected one to the register, and
wherein the specific syntax element in the run_before remaining number updating unit is TotalCoeff.

6. The image decoding apparatus according to claim 3,
wherein the run_before remaining number updating unit includes:
a register configured to retain a specific syntax element as an initial value of run_before remaining number so that the syntax element can be updated;
a subtracter configured to subtract the number of run_before syntaxes received from the bitstream decoding unit from the run_before remaining number retained by the register; and
a selection circuit configured to receive the initial value of the specific syntax element, the run_before remaining number received from the subtracter and an output of the register, and select one of the inputs according to the presence/absence of validity and outputs the selected one to the register, and
wherein the specific syntax element in the run_before remaining number updating unit is TotalCoeff.

7. The image decoding apparatus according to claim 1,
wherein the zerosLeft updating unit receives the specific syntax element decoded by the bitstream decoding unit and the decoded run_before along with respective valid signals, and each time the decoded run_before is inputted, carries out updating calculation using an updating calculation formula (zerosLeft−run_before) by using the specific syntax element as an initial value of zerosLeft, so that updating zerosLeft is repeated until zerosLeft changes to 0, and
wherein the specific syntax element in the zerosLeft updating unit is total_zeros.

8. The image decoding apparatus according to claim 2,
wherein the zerosLeft updating unit receives the specific syntax element decoded by the bitstream decoding unit and the decoded run_before along with respective valid signals, and each time the decoded run_before is inputted, carries out updating calculation using an updating calculation formula (zerosLeft−run_before) by using the specific syntax element as an initial value of zerosLeft, so that updating zerosLeft is repeated until zerosLeft changes to 0, and
wherein the specific syntax element in the zerosLeft updating unit is total_zeros.

9. The image decoding apparatus according to claim 3,
wherein the zerosLeft updating unit receives the specific syntax element decoded by the bitstream decoding unit and the decoded run_before along with respective valid signals, and each time the decoded run_before is inputted, carries out updating calculation using an updating calculation formula (zerosLeft−run_before) by using the specific syntax element as an initial value of zerosLeft, so that updating zerosLeft is repeated until zerosLeft changes to 0, and
wherein the specific syntax element in the zerosLeft updating unit is total_zeros.

10. The image decoding apparatus according to claim 1, further comprising:
a first table group (20Xa) that receives the zerosLeft and the beginning of the bitstream and can decode a plurality of zero run_before syntaxes and one non-zero run_before syntax all at once; and
a second table group (20Xb) that receives the zerosLeft, the beginning of the bitstream and the run_before remaining number and can decode a plurality of zero run_before syntaxes all at once.

11. The image decoding apparatus according to claim 10, further comprising a selection apparatus configured to select one from among a table of the first table group (20Xa) tables and a table of the second table group (20Xb) according to the run_before remaining number received from the run_before remaining number updating unit.

12. The image decoding apparatus according to claim 10, further comprising a unit configured to select a table of the first table group (20Xa) and a table of the second table group (20Xb) all at once, and if there is a corresponding input item in the table of the second table (20Xb), select the output value of the table of the second table (20Xb), and if not, select the output value of the table of the first table (20Xa).

13. The image decoding apparatus according to claim 10, wherein the first table group (20Xa) and the second table group (20Xb) are combined to constitute one table group (20X).

14. The image decoding apparatus according to claim 1, wherein in decoding a syntax element run_before in response to a decode command from the syntax selection unit, prior to the decoding of the syntax element run_before, the bitstream decoding unit decodes TotalCoeff and total_zeros being the specific syntax elements to be used in the run_before remaining number updating unit and the zerosLeft updating unit.

15. An image decoding method comprising:
updating a syntax element located at a beginning of an input bitstream according to a code length thereof and outputting the bitstream;
issuing a decode command for a syntax element to be decoded;
decoding a variable-length code of the syntax element in response to the decode command;
updating a run_before remaining number based on a specific syntax element decoded;
updating zerosLeft based on a specific syntax element decoded; and
receiving the zerosLeft and the beginning of the bitstream and decoding a plurality of zero run_before syntaxes and one non-zero run_before syntax all at once using a first table group (20Xa), or receiving the zerosLeft, the beginning of the bitstream and the run_before remaining number and decoding a plurality of zero run_before syntaxes all at once using a second table group (20Xb).

16. The image decoding method according to claim 15, wherein one is selected from among a table of the first table group (20Xa) tables and a table of the second table group (20Xb) according to the run_before remaining number received from the run_before remaining number updating unit.

17. The image decoding method according to claim 15, wherein a table of the first table group (20Xa) and a table of the second table group (20Xb) are selected all at once, and if there is a corresponding input item in the table of the second table group (20Xb), select the output value of the table of the second table group (20Xb), and if not, select the output value of the table of the first table (20Xa).

18. The image decoding method according to claim 15, wherein the first table group (20Xa) and the second table group (20Xb) are combined to constitute one table group (20X).

19. The image decoding method according to claim 15, wherein in decoding a syntax element run_before in response to a decode command from the syntax selection unit, prior to the decoding of the syntax element run_before, the bitstream decoding unit decodes TotalCoeff and total_zeros being the specific syntax elements to be used in the run_before remaining number updating unit and the zerosLeft updating unit.

20. An image decoding method comprising:
updating a syntax element located at a beginning of an input bitstream according to a code length thereof and outputting the bitstream;
decoding a variable-length code of the syntax element in response to a decode request;
updating a run_before remaining number based on a specific syntax element decoded;
updating zerosLeft based on a specific syntax element decoded;
receiving the zerosLeft and the beginning of the bitstream and decoding a plurality of zero run_before syntaxes and one non-zero run_before syntax all at once using a first table group (20Xa),
or receiving the zerosLeft, the beginning of the bitstream and the run_before remaining number and decoding a plurality of zero run_before syntaxes all at once using a second table group (20Xb).
